(19) United States
(12) Patent Application Publication
(10) Pub. No.: US 2010/0187274 A1
(43) Pub. Date: Jul. 29, 2010

(54) STAND-UP SURFBOARD CARRIER

(76) Inventor: David K.C. Chock, JR., Ewa Beach, HI (US)

Correspondence Address: BELASCO, JACOBS & TOWNSLEY LLP;HOWARD HUGHES CENTER, 6701 CENTER DRIVE WEST, 14th Floor, LOS ANGELES, CA, 90045, US

(21) Appl. No.: 12/360,775

(22) Filed: Jan. 27, 2009

(51) Int. Cl. B65G 7/12

(52) U.S. Cl. 224/578; 224/258; 224/268; 294/142

(57) ABSTRACT

A stand-up surfboard carrier includes two upward facing hook members sized and shaped to fit around a surfboard side edge. The hook members have inner, terminating portions, lower curved portions, and outer extended shaft portions. The shaft portions of the hook members are angled away from a centerline located between them at a first predetermined angle and are joined to a horizontal handle member at an end of each shaft portion. A shoulder strap is looped about the handle member and is sized and shaped to allow the surfboard to rest in the first and second hook members and below an armpit of a user. The handle member is offset outwardly from the shaft portions by a distance sufficient to provide a space for fingers of the user between the handle member and the surfboard. The carrier can be formed in two joining portions which disassemble for transport and storage.

### FIELD OF INVENTION

This invention relates to the field of hauling and carrying devices, and more specifically to a manual carrying rack for a surfboard.

### BACKGROUND OF THE INVENTION

Surfboards are typically large and awkward sporting equipment that must be transported, at a minimum, from an automobile or other conveyance across a beach to the waters edge. Typically, the surfboard is carried under the arm with the hand wrapped under the lower edge of the board. This mode of carrying is a particular problem for those of small stature as their arms are often too short to carry the board comfortably. In addition, as the surfboards can be long, they tend to be difficult to balance and tend to tip and perhaps fall from the user's hand. This problem is further exaggerated with long boards. Numerous solutions have been proposed to handle the problem of comfortable transport for surfboards.

U.S. Pat. No. 6,857,673, issued to Lang, discloses a universal carrier for sports boards that is a unitary structure formed into a U with the upper edge of the front formed or curved forwardly to provide a handle which the user can conveniently and comfortably grasp. The carrier is constructed of a suitable lightweight material such as polycarbonate, acrylic, polyvinyl chloride, ABS or similar material by a fabrication process such as injection molding. In an alternate embodiment the carrier has a frame-like structure formed from a tube or similar stock.

U.S. Patent Application No. 2002/0050725, published for Lang is directed to a universal carrier for sports boards in the form of a unitary structure having a back that is formed into a U which connects to a front with the U-shaped area between the front and the back forming a cradle in which the edge of the board may be placed or nested. The upper edge of the front is also curved in a general U-shape to provide a handle which the user can conveniently and comfortably grasp.

U.S. Pat. No. 4,463,977, issued to Wyatt is directed to a hand-grippable carrier for individual use in carrying a large planar article. The carrier has a hand-grippable cross-member with a centrally located absorbent grip thereon. Each end of the cross-member is connected to a depending arm which extends downwardly therefrom when the carrier is in the transport position. At the end of each depending arm an edge receiving portion is provided. A spacing means that is itself hand-grippable is affixed to the carrier and extends outwardly from the plane containing the arms in the cross-member. The spacing means extends between the handheld cross-member and the vertically positioned article during transport to maintain the article substantially vertical and to protect the individual's hand during transport.

U.S. Pat. No. 2,430,142, issued to Roberts is directed to carrier handles for carrying shopping bags, packages, and also for articles of flat formation such as panels of glass, boards, and the like. The first of the embodiments show a wooden handle with a central bore adapted to receive the ends of wire or the like that form a carrier space for panel-like articles. An adjusting means may be provided by forming the legs in two pieces and having a means to connect them adjustably.

U.S. Pat. No. 6,598,915, issued to Ngo et al. is directed to a tool for lifting a tray or vessel or the like. The tool has a substantially planar body made out of plastic or the like and on either edge of the body depending from the handle is a pair of rims formed of a rod bent in a hook-shape at the lower end.

U.S. Pat. No. 4,190,278, issued to Jancik discloses a panel carrying device for carrying wallboard panels and/or similar panel like structures where the device has a pair of panel support ends connected by curved arms to a panel engaging handle. The curved arms rock or pivot the carrying device upward when a panel is placed on the support ends for easy lifting of the panel.

It is an objective of the present invention to provide a carrying device for a surfboard that is simple and comfortable to use. It is a further objective to provide a carrier that can be used with virtually any surfboard. It is a still further objective of the invention to provide a carrier that is suitable for use by those of small stature or those that have short arms. It is yet a further objective to provide a carrier that can be easily disassembled to allow for easy transport and storage when not is use. Finally, it is an objective of the present invention to provide a stand-up surfboard carrier that is durable, inexpensive and simple to produce.

While some of the objectives of the present invention are disclosed in the prior art, none of the inventions found include all of the requirements identified.

### SUMMARY OF THE INVENTION

The present invention addresses all of the deficiencies of prior art surf board carrier inventions and satisfies all of the objectives described above.

(1) A stand-up surfboard carrier providing the desired features may be constructed from the following components. First and second upward facing hook members are provided. The hook members are sized and shaped to fit about a side edge of a surfboard. Each of the hook members has an inner, terminating portion, a lower curved portion, and outer extended shaft portion. The shaft portions of the first and second hook members are angled away from a centerline located between them at a first predetermined angle. The shaft portions are joined to a horizontal handle member at an end of each shaft portion. A shoulder strap is provided. The strap is looped about the handle member and is sized and shaped to allow the surfboard to rest in the first and second hook members and below an armpit of a user.

(2) In a variant of the invention, the first predetermined angle ranges from 10 to 40 degrees.

(3) In another variant, the handle member is offset outwardly from the shaft portions of the first and second hook members by a distance sufficient to provide a space for fingers of the user between the handle member and the surfboard.

(4) In still another variant, the carrier is formed of resilient tubing material.

(5) In yet another variant, the carrier is coated with a non-slip material.

(6) In a further variant, the shoulder strap further comprises a buckle for adjusting a length of the strap.

(7) In still a further variant, the shoulder strap further comprises a shoulder pad slidably mounted on the strap.

(8) In yet a further variant, the handle member is formed in two connecting portions, permitting disassembly and reassembly of the carrier for compact transport and storage.

(9) In another variant of the invention, the connecting portions of the handle member interlock to prevent rotation between the connecting portions.

(10) In a final variant, the connecting portions of the handle member are joined with mating male and female threads.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a perspective view of the preferred embodiment of the invention in use transporting a surfboard;

FIG. 2 is a perspective view of the FIG. 1 embodiment illustrating the attachment of the shoulder strap to the handle member;

FIG. 3 is a side elevational view of the FIG. 1 embodiment illustrating the offset of the handle member;

FIG. 4 is a front view of the FIG. 1 embodiment illustrating the construction of the carrier and its resilient coating;

FIG. 5 is a perspective view of a second embodiment of the invention illustrating a carrier that disassembles into two portions for transport and storage; and

FIG. 6 is a perspective view of a third embodiment illustrating a carrier that disassembles into two portions for transport and storage and which joins the portions with mating screw threads.

### DETAILED DESCRIPTION OF THE PREFERRED EMBODIMENT

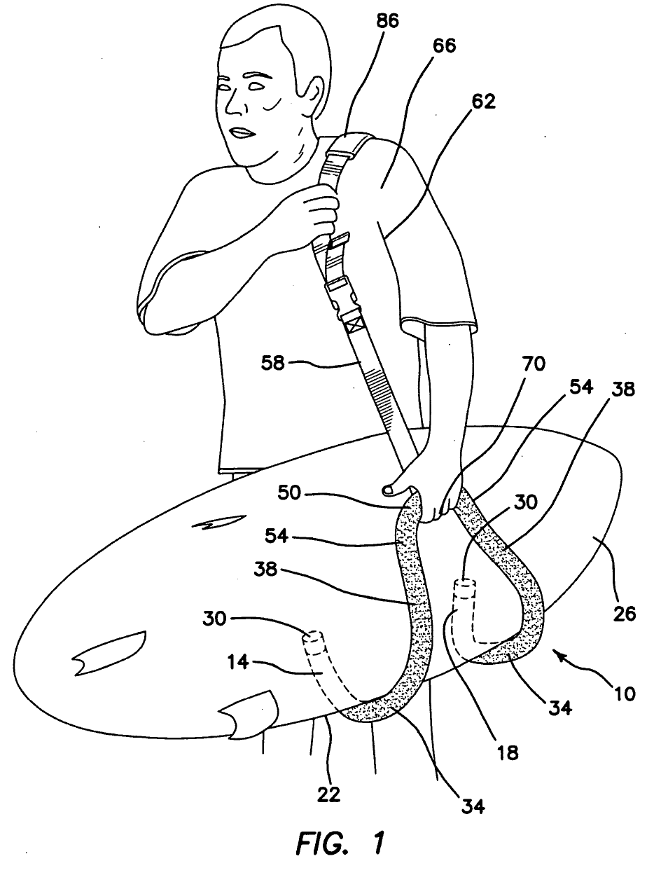

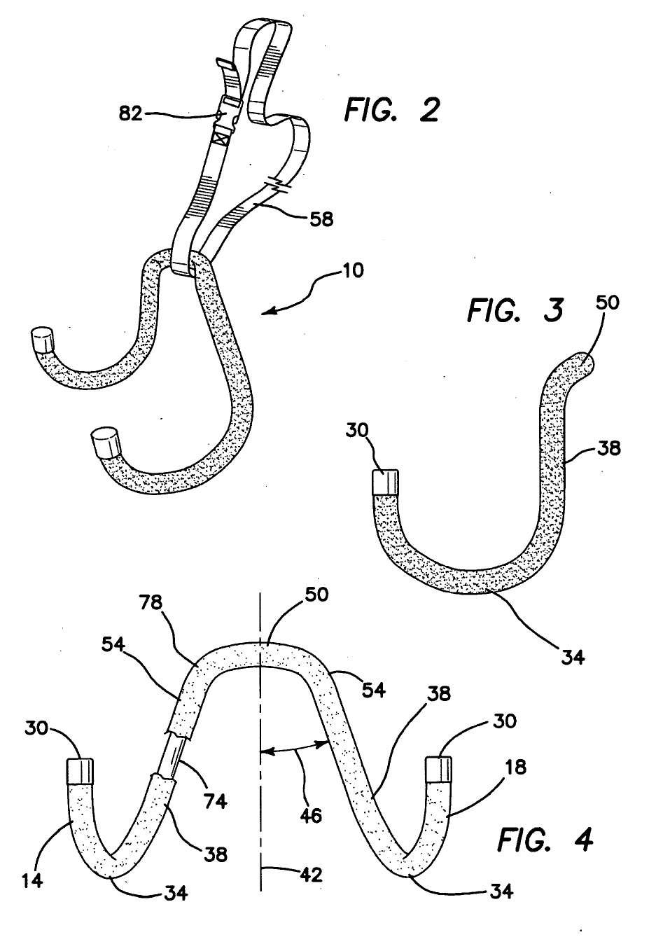

(1) FIGS. 1-6 illustrate a stand-up surfboard carrier 10 providing the desired features may be constructed from the following components. As illustrated in FIGS. 1 and 4, first 14 and second 18 upward facing hook members are provided. The hook members 14, 18 are sized and shaped to fit about a side edge 22 of a surfboard 26. Each of the hook members 14, 18 has an inner, terminating portion 30, a lower curved portion 34, and outer extended shaft portion 38. The shaft portions 38 of the first 14 and second 18 hook members are angled away from a centerline 42 located between them at a first predetermined angle 46. The shaft portions 38 are joined to a horizontal handle member 50 at an end 54 of each shaft portion 38. A shoulder strap 58 is provided. The strap 58 is looped about the handle member 50 and is sized and shaped to allow the surfboard 26 to rest in the first 14 and second 18 hook members and below an armpit 62 of a user 66.

(2) In a variant of the invention, the first predetermined angled 46 ranges from 10 to 40 degrees.

(3) In another variant, as illustrated in FIG. 3, the handle member 50 is offset outwardly from the shaft portions 38 of the first 14 and second 16 hook members by a distance sufficient to provide a space for fingers 70 of the user 66 between the handle member 50 and the surfboard 26.

(4) In still another variant, as illustrated in FIG. 4, the carrier 10 is formed of resilient tubing material 74.

(5) In yet another variant, the carrier 10 is coated with a non-slip material 78.

(6) In a further variant, as illustrated in FIGS. 1 and 4, the shoulder strap 58 further comprises a buckle 82 for adjusting a length of the strap 58.

(7) In still a further variant, the shoulder strap 58 further comprises a shoulder pad 86 slidably mounted on the strap 58.

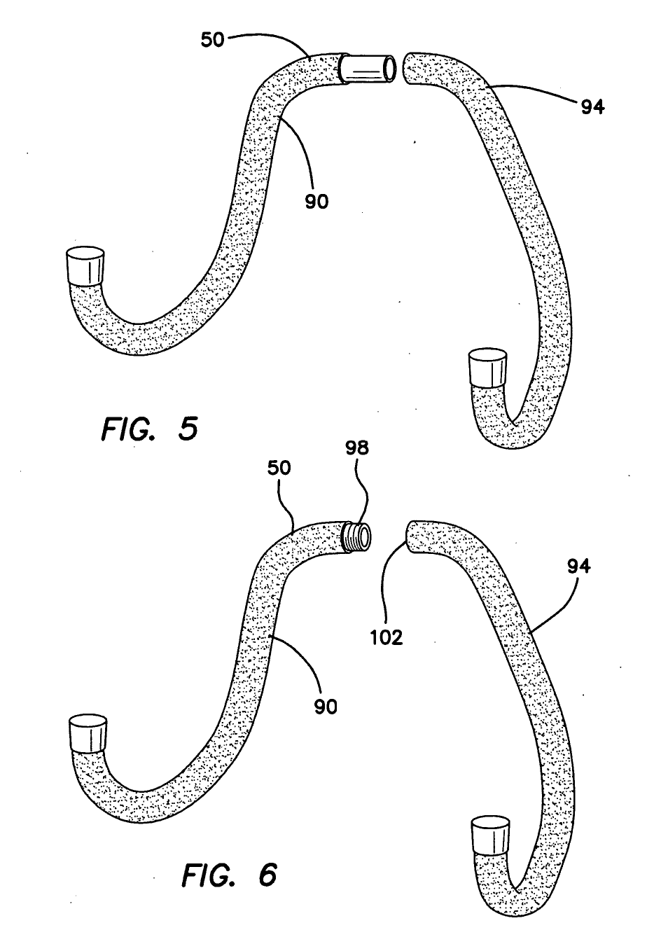

(8) In yet a further variant, as illustrated in FIGS. 5 and 6, the handle member 50 is formed in two connecting portions 90, 94, permitting disassembly and reassembly of the carrier 10 for compact transport and storage.

(9) In another variant of the invention, the connecting portions 90, 94 of the handle member 50 interlock to prevent rotation between the connecting portions 90, 94.

(10) In a final variant, the connecting portions 90, 94 of the handle member 50 are joined with mating male 98 and female 102 threads.

The stand-up surfboard carrier 10 has been described with reference to particular embodiments. Other modifications and enhancements can be made without departing from the spirit and scope of the claims that follow.

1. A stand-up surfboard carrier, comprising:
first and second upward facing hook members, said hook members being sized and shaped to fit about a side edge of a surfboard;
each of said hook members having an inner, terminating portion, a lower curved portion, and outer extended shaft portion;
said shaft portions of said first and second hook members being angled away from a centerline disposed between them at a first predetermined angle;
said shaft portions being joined to a horizontal handle member at an end of each shaft portion; and
a shoulder strap, said strap being looped about said handle member and being sized and shaped to allow the surfboard to rest in said first and second hook members and below an armpit of a user.

2. The stand-up surfboard carrier, as described in claim 1, wherein said first predetermined angle ranges from 10 to 40 degrees.

3. The stand-up surfboard carrier, as described in claim 1, wherein said handle member is offset outwardly from said shaft portions of said first and second hook members by a distance sufficient to provide a space for fingers of the user between said handle member and said surfboard.

4. The stand-up surfboard carrier, as described in claim 1, wherein said carrier is formed of resilient tubing material.

5. The stand-up surfboard carrier, as described in claim 1, wherein said carrier is coated with a non-slip material.

6. The stand-up surfboard carrier, as described in claim 1, wherein said shoulder strap further comprises a buckle for adjusting a length of said strap.

7. The stand-up surfboard carrier, as described in claim 1, wherein said shoulder strap further comprises a shoulder pad slidably mounted on said strap.

8. The stand-up surfboard carrier, as described in claim 1, wherein said handle member is formed in two connecting portions, permitting disassembly and reassembly of said carrier for compact transport and storage.

9. The stand-up surfboard carrier, as described in claim 8, wherein said connecting portions of said handle member interlock to prevent rotation between said connecting portions.

10. The stand-up surfboard carrier, as described in claim 8, wherein said connecting portions of said handle member are joined with mating male and female threads.
